(19) United States
(12) Patent Application Publication
(10) Pub. No.: US 2012/0156948 A1
(43) Pub. Date: Jun. 21, 2012

(54) SUBSTRATE CONNECTING STRUCTURE AND ELECTRONIC DEVICE

(75) Inventor: Masahito Kawabata, Kanagawa (JP)

(73) Assignee: PANASONIC CORPORATION, Osaka (JP)

(21) Appl. No.: 13/392,830

(22) PCT Filed: Feb. 22, 2010
(86) PCT No.: PCT/JP2010/001155

§ 371 Date: Feb. 27, 2012

(30) Foreign Application Priority Data
Aug. 27, 2009 (JP) 2009-196827

(51) Int. Cl. H01R 4/02

(52) U.S. Cl. 439/876

(57) ABSTRACT

There is provided a board connection structure capable of preventing occurrence of a connection failure, which would otherwise be caused by an uneven temperature increase in connection region of circuit boards during thermo-compression bonding.

A board connection structure 10 includes a hard base material 21 having first and second surfaces; a printed circuit board 20 including a plurality of circuit patterns 23 provided on the second surface; a soft base material 31 having first and second surfaces; a flexible circuit board 30 including a plurality of circuit patterns 33 provided on the second surface; a connection sections (connection region) 24, 34 for connecting the circuit patterns 23 of the printed circuit board 20 to the circuit patterns 33 of the flexible circuit board 30 by way of a conductive connection material; and a heat conduction layer 50 that is provided on the first surface of the flexible circuit board 30 and that exhibits predetermined heat conductivity that is higher than heat conductivity of the hard base material 21 of the circuit board. The heat conduction layer 50 opposes some of the plurality of circuit patterns 33 of the flexible circuit board 30 by way of the soft base material 31 and is provided so as to stretch between a part of the connection region and a region adjacent to the connection region.

### TECHNICAL FIELD

The present invention relates to a board connection structure for interconnecting circuit boards by way of a conductive connection material and electronic equipment having the board connection structure.

### BACKGROUND ART

In electronic equipment; for instance, a cellular phone, a hard printed wiring board and a soft flexible circuit board are set within an enclosure, and connection portions of the circuit boards are electrically connected together. FIG. 14 shows processes for preparing a board connection structure.

As shown in FIG. 14, a printed wiring board 20 has a mount section 22 and a connection section 24 (a connection region). In the mount section 22, a plurality of electronic components are implemented on a surface of a hard base material 21 that opposes a flexible circuit board 30. Further, a plurality of circuit patterns 23 are arranged side by side in the connection section 24 so as to extend up to the mount section 22. A transparent coverlay 25 (or a resist) that covers the mount section 22 is provided on both a front surface of the printed circuit board 20 and a back surface that is the other side of the front surface. The circuit patterns 23 remain exposed on a front surface side of the connection section 24 by opening the coverlay 25.

The flexible circuit board 30 has a connection section 34 (a connection region) and an adjacent region 35. In the connection region 34, a plurality of circuit patterns 33 are arranged side by side on a front surface of a soft base material 31 that opposes the printed circuit board 20. The adjacent section 35 is adjacent to the connection section 34 in its widthwise direction.

When the printed circuit board 20 and the flexible circuit board 30 are connected together, the connection section 24 of the printed circuit board 20 and the connection section 34 of the flexible circuit board 30 are overlapped one on top of the other with an un-illustrated ACF (anisotropic conductive film) interposed therebetween in such a way that an overlap exists between the circuit patterns 23 and 33 as shown in FIG. 16. The connection sections 24 and 34 are nipped from the outside by means of a compression heating tool 12a and a receiving tool 12b of a thermo-compression bonding jig 12, thereby applying pressure and heat to the connection sections 24 and 34 for a predetermined period of time. The circuit patterns 23 and 33 are fixed together while remaining in plane contact with each other by means of fused and cured ACF, whereupon the printed circuit board 20 and the flexible circuit board 30 are electrically connected together.

Several proposals for making a reliable connection by means of a conductive connection material during thermo-compression bonding have hitherto been made. For instance, Patent Document 1 is intended to make a thickness of a coverlay on a back surface of a connection section of a flexible circuit board locally greater at a location close to a mount section of a printed circuit board. The thus-locally-increased thickness of the area makes heat, which arises during thermo-compression bonding, difficult to travel to a connection section of the printed circuit board and an area of the connection section of the flexible circuit board close to the mount section, thereby preventing a temperature increase in the area of the connection section close to the mount section and making the temperature of the connection sections uniform.

Patent Document 2 is directed toward opening a shield on a back surface of a flexible circuit board only at a connection section of circuit patterns, thereby making heat of a thermo-compression bonding jig easy to travel to the connection section.

Patent Document 3 is directed toward providing a back surface of a flexible circuit board with a heat radiation member whose shape is linearly symmetrical about a center line, like a triangular shape, so as to come close to a connection section of circuit patterns on a front surface. Radiation of heat which will be emitted during thermo-compression bonding is controlled by the heat radiation member, thereby rendering the temperature of a connection section of a printed circuit board and the temperature of the connection section of the flexible circuit board uniform.

Patent Document 4 is directed toward providing, on a back surface of a connection section of a flexible circuit board, a dummy pattern for each of conductor lines making up a circuit patterns of the flexible circuit board. Heat which will be emitted during thermo-compression bonding is caused to travel to each of the conductor lines by means of dummy patterns, thereby accomplishing a firm bond.

### Related Art Documents

### Patent Documents

Patent Document 1: International Publication WO 2007/072570

Patent Document 2: JP-A-06-090082

Patent Document 3: JP-A-2005-166780

Patent Document 4: JP-B-4-044440

### SUMMARY OF THE INVENTION

Problem that the Invention is to Solve

Incidentally, in order to let the printed circuit board 20 conform to a reduction in the size and thickness of an enclosure, the mount section 22 and the connection section 24 are often arranged in L-shaped patterns that are out of alignment with each other, as shown in FIG. 14, rather than being arranged into a line. For this reason, when the connection section 24 of the printed circuit board 20 and the connection section 34 of the flexible circuit board 30 are heated, a region 10A1 of the connection sections 24 and 34 that is close to the mount section 22 of the printed circuit board 20 is inclined to easily dissipate heat to the mount section 22, as shown in FIG. 15, by way of the hard base material 21 as designated by arrow Q1. On the contrary, a region 10A2 that is distant from the mount section 22 less easily dissipates heat to the mount section 22 by way of the hard base material 21 as designated by arrow Q2, so that a build-up of heat tends to occur. In the region 10A1 of the connection sections 24 and 34 that is close to the mount section 22, a left alignment mark m1; for instance, is presumed to assume a temperature Tm1. Further, in relation to the region 10A2 distant from the mount section 22, a right alignment mark m2; for instance, is presumed to assume a temperature Tm2. As shown in FIG. 17, the temperature Tm1 becomes lower, and the temperature Tm2 becomes higher. Thus, a difference in heating temperature occurs between the region 10A1 close to the mount section 22 in the connection sections 24 and 34 and the region 10A2 distant from the mount section 22 in the same.

If excessive heating occurs in the region 10A2 of the connection sections 24 and 34 that is distant from the mount section 22 for reasons of such an unevenness of heating temperature, the region 10A2 will undergo extension of the flexible circuit board 30 or spring-back which will arise when the print circuit board is cooled. This will make it impossible to make a highly accurate connection between the circuit patterns 23 and 33. In the meantime, if insufficient heating occurs in the region 10A1 of the connection sections 24 and 34 that is close to the mount section 22, the resin of a bonding material on the region 10A1 will become insufficiently thermally-cured, so that the circuit patterns 23 and 33 cannot be firmly connected together.

A problem of connection quality due to the unevenness of heating temperature of the connection sections also occurs when the circuit patterns 23 and 33 are connected together by use of solder. In relation to solder, if excessive heating occurs in the region 10A2 of the connection sections 24 and 34 that is distant from the mount section 22, extension of the flexible circuit board 30 at the region 10A2, dilation of a burnt solder alloy, and corrosion of a copper foil making up the circuit patterns 23 and 33 will take place, which will in turn raise a problem of connection quality, such as embrittlement of a solder junction interface. Furthermore, a time that elapses before the fused solder is cooled to a temperature at which the fused solder becomes solid will increase, which in turn causes a decrease in productivity of electronic equipment. In the meantime, when deficient heating occurs in the region 10A1 close to the mount section 22, solder becomes insufficiently fused, so that a firm connection cannot be made in the circuit patterns 23 and 33 at the region 10A1.

A challenge to be met by the present invention is to provide a board connection structure that prevents occurrence of an uneven temperature increase in the connection region between circuit boards when the two circuit boards are bonded together by thermal compression bonding by use of a conductive connection material, thereby preventing occurrence of a connection failure.

### Means for Solving the Problem

A board connection structure of the present invention comprises a first circuit board including a base material that has a first surface and a second surface and a plurality of circuit patterns provided on the second surface; a second circuit board including a base material that has a first surface and a second surface and a plurality of circuit patterns provided on the second surface; a connection region that connects the circuit patterns of the first circuit board to the circuit patterns of the second circuit board by a conductive connection material; and a heat conduction layer that is provided on the first surface of the second circuit board and that exhibits predetermined heat conductivity which surpasses heat conductivity of the base material of the second circuit board, wherein the heat conduction layer opposes a part of the plurality of circuit patterns of the second circuit board by the base material of the second circuit board and is provided so as to extend from a part of the connection region to a region adjacent to the connection region.

According to the configuration, a range where the heat conduction layer on the first surface of the second circuit board is provided is set on a region where heat of the connection region of the first circuit board and the second circuit board is likely to build up and a region adjacent to the connection region. The heat of the region where heat of the connection region is likely to build up can travel to the heat conduction layer during thermo-compression bonding, so that heat can be dissipated. Consequently, occurrence of uneven temperature increase in the connection region of the circuit boards is prevented, and the circuit patterns of the first circuit board and the circuit patterns of the second circuit board can well be connected together by means of the conductive connection material.

In one mode of the present invention, an area of the heat conduction layer provided in the region adjacent to the connection region is larger than an area of the heat conduction layer provided in the part of the connection region.

As the area of the heat conduction layer becomes greater, greater heat capacity and better travel of heat are accomplished, so that a greater heat dissipation effect is yielded. In the configuration, the area of the heat conduction layer provided in the region adjacent to the connection region is made greater than the area of the heat conduction layer provided in a part of the connection region. Hence, the heat that built up in the part of the connection region effectively travels from the heat conduction layer provided in the part of the connection region to the heat conduction layer provided adjacent to the connection region, so that the heat can be dissipated outside.

In one mode of the present invention, the conductive connection material is a hot-melt conductive material or a thermosetting conductive resin.

According to the configuration, the conductive connection material can be applied to the present invention whether the conductive connection material is solder (a hot-melt conductive material) or an anisotropic conductive resin (a thermosetting conductive resin).

In one mode of the present invention, opening windows are formed in the connection region of the second circuit board; alignment marks are provided in the connection region of the first circuit board and the connection region of the second circuit board; and an overlap between the alignment marks of the first circuit board and the second circuit board is observable through the opening windows.

According to the configuration, the circuit patterns of the first circuit board and the circuit patterns of the second circuit board can be aligned to each other by means of taking, as reference symbols, the alignment marks of the first circuit board and the second circuit board.

In one mode of the present invention, the heat conduction layer is formed from metal.

According to the configuration, heat conduction layer exhibiting a large heat dissipation characteristic can be readily formed.

In one mode of the present invention, the heat conduction layer and the circuit patterns of the second circuit board are formed from the same metal.

According to the configuration, the heat conduction layer and the circuit patterns of the second circuit board can be provided by utilization of the conductor foil of the same metal provided on both surfaces of a blank circuit board.

In one mode of the present invention, the heat conduction layer is formed from a conductive resin.

According to the configuration, a heat conduction layer formed from a conductive resin can also be used as the heat conduction layer.

In one mode of the present invention, the conductive resin is also provided on a flexible board connected to the connection region.

In the flexible board, the shield is formed from a conductive resin. According to the configuration, heat migration can be controlled by utilization of the shield of the flexible board connected to the connection region of the second circuit board.

In one mode of the present invention, the heat conduction layer is provided so as to oppose the plurality of circuit patterns even in a part other than the part of the connection region; and wherein the heat conduction layer in another part of the connection region opposes only some of the plurality of circuit patterns.

According to the configuration, the heat conduction layer is also provided in another part other than the part of the connection region, so that the entirety of the connection region can be evenly pressure-bonded along with substantially-constant rigidity. Further, the heat conduction layer of the other part opposes only some of the plurality of circuit patterns, and hence there is not impaired an effect of increasing the quantity of heat released from the region that is the part of the connection region and where heat is likely to build up.

In one mode of the present invention, the heat conduction layer in the other part of the connection region is formed into a strip shape.

According to the configuration, the heat conduction layer in the other part of the connection region is formed into a strip shape, whereby a heat conduction layer provided in another part other than the part of the connection region is realized.

In one mode of the present invention, a slit is formed in the strip-shaped heat conduction layer.

According to the configuration, heat conduction effected by the heat conduction layer is interrupted at the location where the slit is formed. Hence, the temperature of the connection region can be increased at the position where the slit is formed.

In one mode of the present invention, the slit is provided at the position where the strip-shaped heat conduction layer crosses opposing circuit patterns.

According to the configuration, the slit crosses the circuit patterns, and hence a part of the circuit patterns to be crossed inevitably oppose the heat conduction layer. The circuit patterns can reliably be pressurized, heated, and connected.

Electronic equipment of the present invention has the board connection structure.

According to the configuration, there can be provided electronic equipment that exhibits superior quality of a connection between circuit patterns of a first circuit board and circuit patterns of a second circuit board.

### Advantage of the Invention

According to the present invention, it is possible to provide a board connection structure that prevents occurrence of an uneven temperature increase in a connection region between circuit boards when the two circuit boards are bonded together by thermal compression bonding by use of a conductive connection material, thereby preventing occurrence of a connection failure, as well as to provide electronic equipment having the base connection board.

### BRIEF DESCRIPTION OF THE DRAWINGS

FIG. 1 is an exploded perspective view showing a board connection structure of a first embodiment of the present invention.

FIG. 2 is a process chart for preparing the board connection structure.

FIG. 3 is a plan view of the board connection structure.

FIG. 4 is a cross sectional view taken along line A-A′ shown in FIG. 3.

FIG. 5 is a graph schematically showing a temperature distribution of connection sections.

FIG. 6 is an exploded perspective view showing a board connection structure of a second embodiment of the present invention.

FIG. 7 is a plan view of the board connection structure.

FIG. 8 is a cross sectional view taken along line A-A′ shown in FIG. 7.

FIG. 9 is a plan view showing other example board connection structures of a third embodiment of the present invention.

FIG. 10 is a plan view showing other example board connection structures of a fourth embodiment of the present invention.

FIG. 11 is a view showing a board connection structure of a fifth embodiment of the present invention.

FIG. 12 is a view showing a board connection structure of a sixth embodiment of the present invention.

FIG. 13 is a view showing a board connection structure of a seventh embodiment of the present invention.

FIG. 14 is a process chart for preparing a related-art board connection structure.

FIG. 15 is a plan view of the board connection structure.

FIG. 16 is a cross sectional view taken along line A-A′ shown in FIG. 15.

FIG. 17 is a graph schematically showing a temperature distribution of connection sections.

### EMBODIMENTS FOR IMPLEMENTING THE INVENTION

Embodiments of a board connection structure of the present invention are hereunder described by reference to the drawings.

### First Embodiment

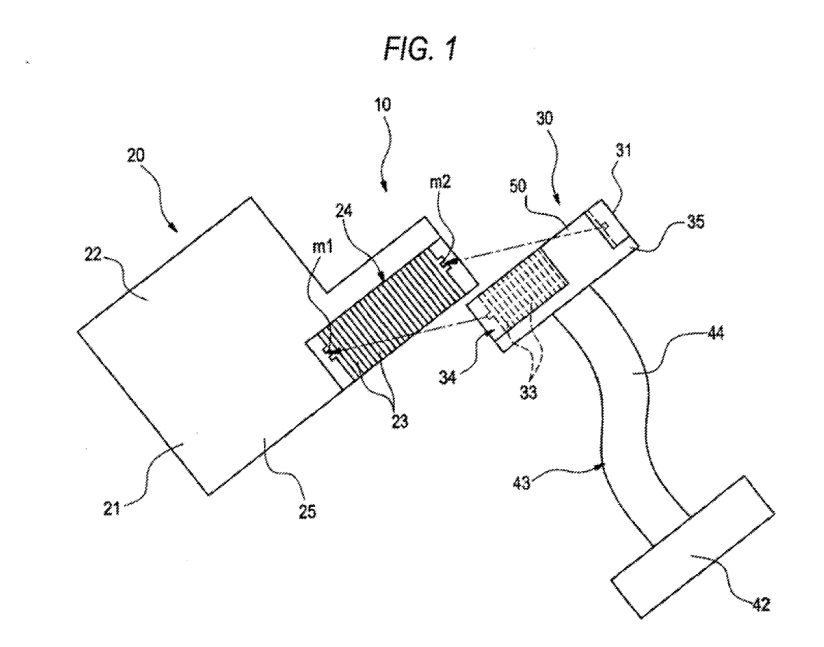

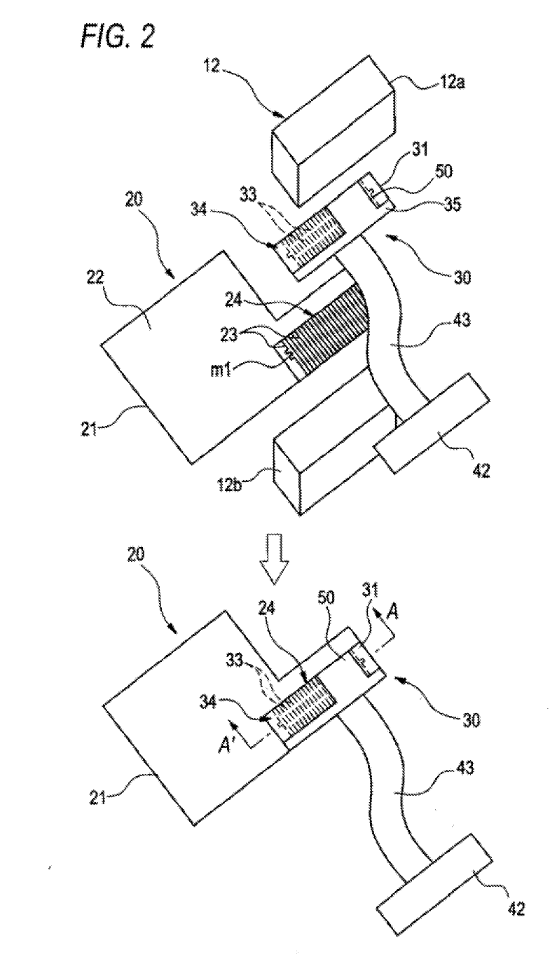

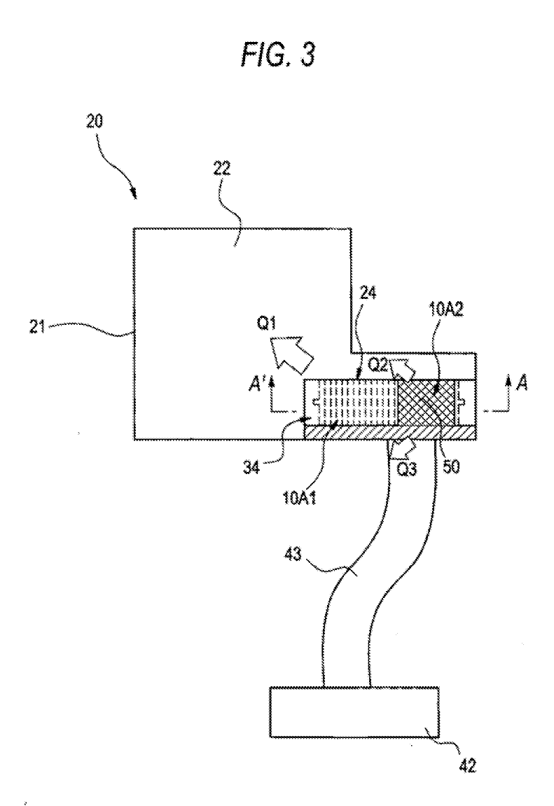

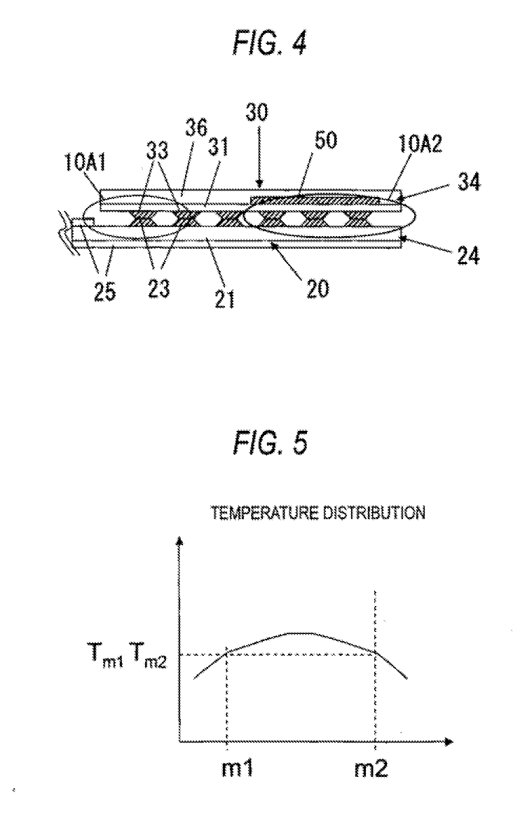

FIG. 1 is an exploded perspective view showing a board connection structure of a first embodiment of the present invention; FIG. 2 is a process chart for preparing the board connection structure; FIG. 3 is a plan view of the board connection structure; and FIG. 4 is a cross sectional view taken along line A-A′ shown in FIG. 3.

As shown in FIG. 1, a board connection structure 10 of a first embodiment has a printed circuit board (a first circuit board) 20 accommodated in an un-illustrated upper enclosure of electronic equipment and a flexible circuit board (a second circuit board) 30. The printed circuit board 20 has a hard base material 21 assuming the shape of the letter L when viewed in plane. As shown in FIGS. 1 and 3, the printed circuit board 20 has, on a front surface (a second surface) of the hard base material 21 opposing the flexible circuit board 30, a rectangular mount section 22 on which a plurality of electronic components are mounted and an elongated connection section 24 (a connection region) that projects from one end of the mount section 22 so as to extend up to the mount section 22 and in which a plurality of circuit patterns 23 are arranged side by side. A coverlay 25 (or a resist) covering the mount section 22 is provided on the front surface (the second surface) of the printed circuit board 20 and a back surface (a first surface) on the other side thereof, thereby protecting the circuit patterns of the mount section 22. The coverlay 25 on a front surface side of the connection section 24 is opened, whereby the plurality of circuit patterns 23 are exposed.

The flexible circuit board 30 is connected to a function module 42 housed in an un-illustrated enclosure of electronic equipment, by means of a flexible joint section 43 made of a flexible board. The flexible circuit board 30 has a soft base material 31 that has substantially the same shape as that of the connection section 24 of the printed circuit board 20. The flexible circuit board 30 has, on a front surface (a second surface) of the soft base material 31 opposing the printed circuit board 20, a connection section 34 in which a plurality of circuit patterns 33 are arranged side by side and an adjacent section 35 situated adjacent to the connection section 34 in its widthwise direction. The flexible joint section 43 is connected to the connection section 34 by way of the adjacent section 35 of the flexible circuit board 30. A surface of the flexible joint section 43 is covered with a conductive shield 44.

In order to increase a quantity of heat released from the region 10A2 that is distant from the mount section 22 of the printed circuit board 20, a heat conduction layer 50 exhibiting heat conductivity that is higher than that exhibited by the soft base material 31 is locally provided on a back surface (a first surface) that is on the other side of the front surface (the second surface) of the flexible circuit board 30. In the present embodiment, copper foil provided on the back surface of the soft base material 31 is not fully etched away but partially left, thereby forming the heat conduction layer 50. The heat conduction layer 50 is, in detail, formed over the adjacent section 35 located adjacent to the connection section 34 as well as over the region 10A2 (FIG. 3) that opposes a portion of the connection section 34 and that is distant from the region 10A2 of the mount. section 22; namely, some of the plurality of circuit patterns 33 by way of the soft base material 31. Preferably, an area S2 (an area of a hatched portion of the heat conduction layer 50 shown in FIG. 3) of the adjacent section 35 should be larger than an area S1 of the heat conduction layer 50 in the connection section 34 (an area of a grid portion of the heat conduction layer 50 shown in FIG. 3). The reason for this is that greater heat capacity, faster travel of heat, and a greater heat dissipation effect are achieved when the area of the heat conduction layer is greater. A back surface of the flexible circuit board 30 is covered with a substantially-transparent coverlay 36 provided on the heat conduction layer 50 from above (FIG. 4). The entire connection section 34 of the flexible circuit board 30 thereby comes to assume a substantially uniform thickness.

Each of the connection section 24 of the printed circuit board 20 and the connection section 34 of the flexible circuit board 30 is provided with a right alignment mark m2 and a left alignment mark m1. In order to electrically connect the printed circuit board 20 to the flexible circuit board 30, an un-illustrated ACF (anisotropic conductive resin film) is sandwiched as a conductive connection material between the connection section 24 of the printed circuit board 20 and the connection section 34 of the flexible circuit board 30. Further, while the left and right alignment marks m1 and m2 of the connection sections 24 and 34 which can be seen through the coverlay 36 of the flexible circuit board 30 are taken as reference symbols, the connection sections 24 and 34 are superimposed in such a way that an overlap exists between the circuit patterns 23 and 33. In this state, the connection sections 24 and 34 are nipped from the outside by means of the compression heating tool 12a and the receiving tool 12b of the thermo-compression bonding jig 12, thereby applying pressure and heat to the connection sections 24 and 34 for a predetermined period of time. The ACF bonding material is thereby fused with the heat originating from the compression heating tool 12a. The bonding material extruded from a space between the circuit patterns 23 and 33 adheres to both the hard base material 21 of the connection section 24 and the soft base material 31 of the connection section 34. The bonding material is thermally cured, whereby the circuit patterns 23 and 33 are fixedly held in a plane contact with each other. Thus, the printed circuit board 20 and the flexible circuit board 30 are electrically connected together.

The heat conduction layer 50 is provided on the soft base material 31 of the flexible circuit board 30 so as to stretch from the region of the connection section 24 that is distant from the mount section 22 of the printed circuit board 20 up to the adjacent section 35 that is adjacent to the connection section 34. Hence, during operation of heat connection, the heat applied to the connection section 24 of the printed circuit board 20 and the connection section 34 of the flexible circuit board 30 travels to the mount section 22 at the region 10A2 that is distant from the mount section 22, by way of the hard base material 21 as designated by arrow Q2. Further, the heat also travels from the connection sections 24 and 34 to the heat conduction layer 50 as designated by arrow Q3. The heat also travels to the flexible joint section 43 by way of the heat conduction layer 50. In this case, since the area S2 of the adjacent section 35 of the heat conduction layer 50 is made larger than the area S1 of the connection section 34, the quantity of heat traveling from the adjacent section 35 of the heat conduction layer 50 to the flexible joint section 43 is increased, whereby heat can be dissipated. It is thereby possible to prevent generation of a build-up of heat in the region 10A2 of the connection sections 24 and 34 that is distant from the mount section 22, in much the same way as in the region 10A1 of the connection sections 24 and 34 that is close to the mount section 22 (heat travels to the mount section 22 by way of the hard base material 21 as designated by arrow Q1).

As a result, a heating temperature of the region 10A1 of the connection sections 24 and 34 that is close to the mount section 22 and a heating temperature of the region 10A2 of the connection sections 24 and 34 that is distant from the mount section 22 can be made substantially equal to each other, as can be seen in FIG. 5 that shows a temperature Tm1 of the left alignment mark m1 assigned to the region 10A1 of the connection sections 24 and 34 that is close to the mount section 22 and a temperature Tm2 of the right alignment mark m2 assigned to the region 10A2 that is distant from the mount section 22. Thus, the unevenness of heating temperature can be lessened. Therefore, a failure of a connection between the circuit patterns 23 and 33, which would otherwise be caused by excessive heating of the region 10A2 of the connection sections 24 and 34 that is distant from the mount section 22 and insufficient heating of the region 10A1 close to the mount section 22, can be prevented, so that a highly accurate connection between the circuit patterns 23 and 33 can be accomplished.

The first embodiment has mentioned the case where the circuit patterns 23 of the connection section 24 of the printed circuit board 20 and the circuit patterns 33 of the connection section 34 of the flexible circuit board 30 are connected together by use of the ACF as a conductive connection material. However, the connection can also be accomplished by use of solder that is a hot-melt conductive material. Likewise, occurrence of a connection failure between the circuit patterns 23 and 33, which would otherwise be caused by the unevenness of heating temperature, can be prevented.

### Second Embodiment

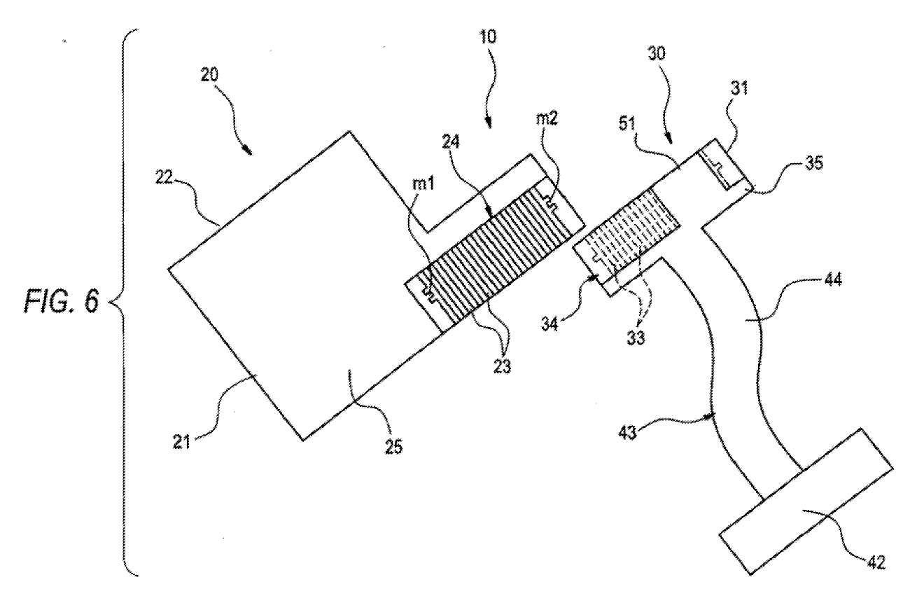

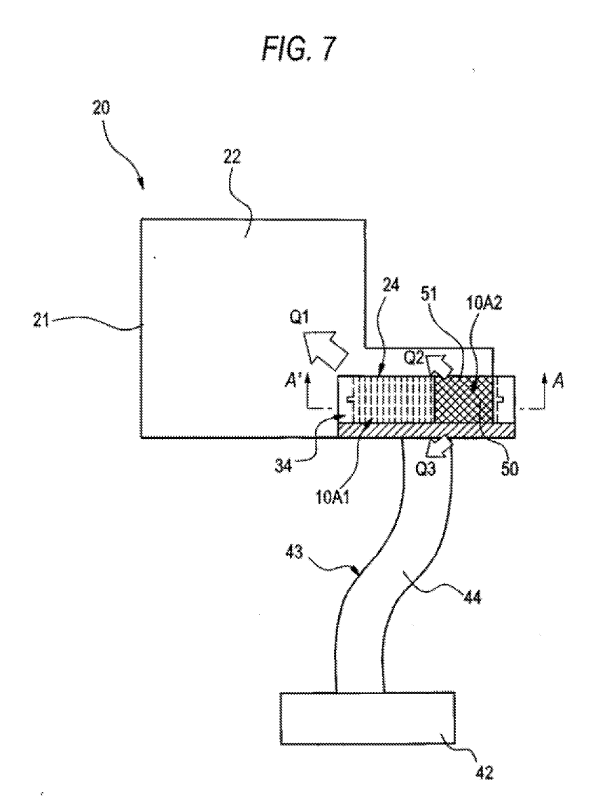

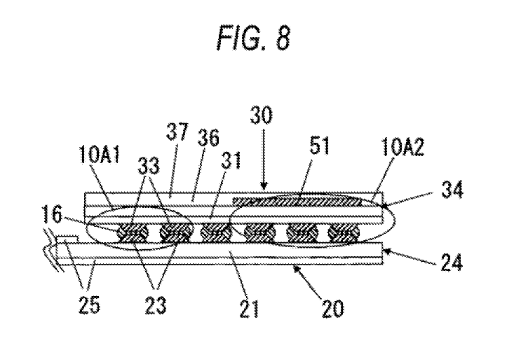

A second embodiment of the present invention is now described by reference to FIGS. 6 through 8. FIG. 6 is an exploded perspective view showing a board connection structure of a second embodiment of the present invention: FIG. 7 is a plan view of the board connection structure; and FIG. 8 is a cross sectional view taken along line A-A′ shown in FIG. 7. In FIGS. 6 through 8, the elements that are the same as those described in connection with the first embodiment by reference to FIGS. 1 through 7 are assigned the same reference numerals, and their explanations are omitted.

In the first embodiment, the conductive shield 44 of the flexible joint section 43 is not provided on the back surface of the flexible circuit board 30. In the second embodiment, a heat conduction layer 51 made up of the conductive shield 44 of the flexible joint section 43 is partially provided on the coverlay 36 on the back surface (the first surface) that is on the other side of the front surface (the second surface) of the flexible circuit board 30 opposing the printed circuit board 20. As in the first embodiment, a range where the heat conduction layer 51 is provided corresponds to an area from the region of the connection section 34 that opposes some of the plurality of circuit patterns 33 by way of the soft base material 31 and that are distant from the mount section 22 of the printed circuit board 20, to the adjacent section 35 located adjacent to the connection section 34. Preferably, the area S2 of the heat conduction layer 51 in the adjacent section 35 should be larger than the area S1 of the heat conduction layer 51 in the connection section 34, in much the same manner as in the first embodiment.

The back surface of the flexible circuit board 30 is covered with the coverlay 36 and an overcoat 37 that is a substantially transparent insulation resin film provided on the heat conduction layer 51 (FIG. 8). The entirety of the connection section 34 of the flexible circuit board 30 thereby assumes a substantially uniform thickness.

In the second embodiment, the printed circuit board 20 and the flexible circuit board 30 are electrically connected by use of solder 16 (FIG. 8). At least one of the circuit pattern 23 of the connection section 24 of the printed circuit board 20 and the circuit patterns 33 of the connection section 34 of the flexible circuit board 30 is previously coated with the solder 16. Further, while the left and right alignment marks m1 and m2 of the connection sections 24 and 34 which can be seen through the overcoat 37 of the flexible circuit board 30 are taken as reference symbols, the connection sections 24 and 34 are superimposed in such a way that an overlap exists between the circuit patterns 23 and 33. In this state, in much the same way as shown in FIG. 2, the connection sections 24 and 34 are nipped from the outside by means of the compression heating tool 12a and the receiving tool 12b of the thermo-compression bonding jig 12, thereby applying pressure and heat to the connection sections 24 and 34 for a predetermined period of time. The solder 16 is thereby fused with the heat originating from the compression heating tool 12a and cooled and cured, whereby the circuit patterns 23 and 33 are metal-joined together. Thus, the printed circuit board 20 and the flexible circuit board 30 are electrically connected together.

The heat conduction layer 51 is provided on the soft base material 31 of the flexible circuit board 30 so as to stretch from the region of the connection section 24 that is distant from the mount section 22 of the printed circuit board 20 up to the adjacent section 35 that is adjacent to the connection section 34. Hence, during operation of heat connection, the heat applied to the connection section 24 of the printed circuit board 20 and the connection section 34 of the flexible circuit board 30 travels to the mount section 22 at the region 10A2 that is distant from the mount section 22, by way of the hard base material 21 as designated by arrow Q2. Further, the heat also travels from the connection sections 24 and 34 to the heat conduction layer 51 as designated by arrow Q3. The heat also travels to the flexible joint section 43 by way of the heat conduction layer 51. As in the case of the first embodiment, since the area S2 of the adjacent section 35 of the heat conduction layer 51 is made larger than the area S1 of the connection section 34, the quantity of heat traveling from the adjacent section 35 of the heat conduction layer 51 to the flexible joint section 43 is increased, whereby heat can be dissipated. In much the same way as in the region 10A1 of the connection sections 24 and 34 that is close to the mount section 22 and where heat travels to the mount section 22 by way of the hard base material 21 as designated by arrow Q1, generation of a build-up of heat in the region 10A2 of the connection sections 24 and 34 that is distant from the mount section 22 can be prevented.

As a result, a heating temperature of the region 10A1 of the connection sections 24 and 34 that is close to the mount section 22 and a heating temperature of the region 10A2 of the connection sections 24 and 34 that is distant from the mount section 22 can be made substantially equal to each other, in much the same way as in the first embodiment. Therefore, a failure of a connection between the circuit patterns 23 and 33, which would otherwise be caused by excessive heating of the region 10A2 of the connection sections 24 and 34 that is distant from the mount section 22 and insufficient heating of the region 10A1 close to the mount section 22, can be prevented, so that a highly accurate connection between the circuit patterns 23 and 33 can be accomplished. In the case of solder, when excessive heating is performed, there is increased the time that elapses before fused solder is cooled to a temperature at which the fused solder becomes cured. However, a problem of excessive heating is eliminated, and hence productivity of electronic equipment will not fall.

The second embodiment has mentioned the case where the circuit patterns 23 of the connection section 24 of the printed circuit board 20 and the circuit patterns 33 of the connection section 34 of the flexible circuit board 30 are connected together by use of the solder as a conductive connection material. However, the connection can also be accomplished by use of the ACF in the same manner as in the first embodiment. Likewise, occurrence of a connection failure between the circuit patterns 23 and 33, which would otherwise be caused by the unevenness of heating temperatures of the connection sections 24 and 34, can also be prevented.

### Third Embodiment

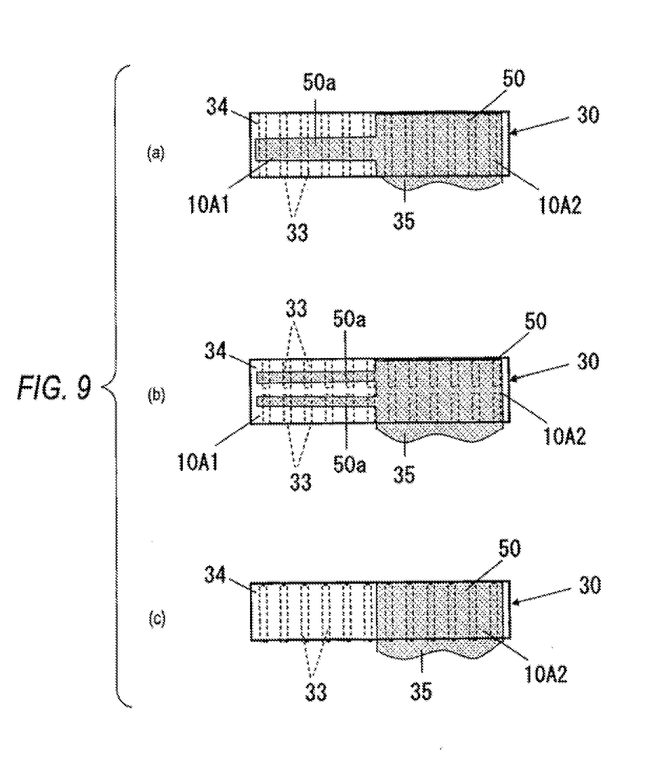

A third embodiment of the present invention is described by reference to FIG. 9. In the first embodiment, the heat conduction layer 50 of the flexible circuit board 30 is provided in only the distant region 10A2 of the connection section 24, as shown in FIG. 9C, so that only the region 10A2 of the connection sections 24 and 34 that is distant from the mount section 22 of the printed circuit board 20 can easily dissipate heat.

On the contrary, in the third embodiment, the heat conduction layer 50 of the flexible board 30 is formed so as to have a strip-shaped heat conduction layer 50a so as to extend over the entirety of the circuit patterns 33 of the connection section 34, as shown in FIG. 9(a) or 9(b).

In the embodiment shown in FIG. 9(a), the heat conduction layer 50 is formed so as to have one thread of the strip-shaped heat conduction layer 50a that narrowly extends as far as the region 10A1 which is close to the mount section 22 of the printed circuit board 20. In this case, the thickness and rigidity of the entire connection section 34 become uniform. The entirety of the circuit patterns 33 of the connection section 34 can substantially evenly be pressure-bonded to the circuit patterns 23 of the connection section 24 of the printed circuit board 20. Further, the strip-shaped heat conduction layer 50a opposes only some of the respective circuit patterns 33. Hence, the effect of an increase in the quantity of heat dissipated by the region 10A2 of the connection sections 24 and 34 that is distant from the mount section 22 of the printed circuit board 20 is not impaired greatly.

An embodiment shown in FIG. 9(b) is directed toward a case where the circuit pattern 33 is realized in the form of two threads along its longitudinal direction, so as to oppose the widthwise direction of the connection section 34. In this case, the heat conduction layer 50 is formed such that the strip-shaped heat conduction layer 50a is formed from two threads. Even in this case, the entirety of the connection section 34 assumes a substantially uniform thickness and rigidity. Thus, the entire circuit patterns 33 of the connection section 34 can be substantially evenly pressure-bonded to the circuit patterns 23 of the connection section 24 of the printed circuit board 20.

The foregoing third embodiment has mentioned the heat conduction layer 50 made of copper foil. However, the same can also be true of the heat conduction layer 51 formed from the shield described in connection with the second embodiment. Even in this case, the entirety of the connection section 34 assumes a uniform thickness and rigidity. The entire circuit patterns 33 of the connection section 34 can be substantially evenly pressure-bonded to the circuit patterns 23 of the connection section 24 of the printed circuit board 20.

### Fourth Embodiment

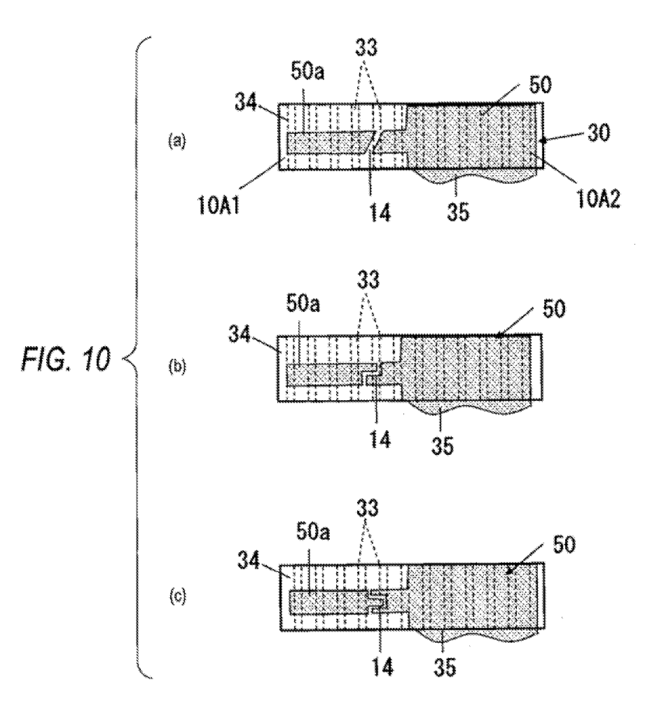

A fourth embodiment of the present invention is described by reference to FIG. 10. In the fourth embodiment, a slit 14 is opened, as shown in FIG. 10, at an arbitrary point in the strip-shaped heat conduction layer 50a of the heat conduction layer 50 of the connection section 34 of the flexible circuit board 30 of the third embodiment shown in FIG. 9(a). The slit 14 is provided at a position where it crosses the circuit patterns 33 opposing the strip-shaped heat conduction layer 50a. The slit 14 can accordingly assume any shape, such as the shape of a slope [FIG. 10(a)], the shape of a hook [FIG. 10(b)], and the shape of the letter C [FIG. 10(c)].

Heat conduction that is effected by the heat conduction layer stops at the location where the slit 14 is provided, so long as such a slit 14 is provided at an arbitrary position on the strip-shaped heat conduction layer 50a. Consequently, if the slit 14 is previously provided in the strip-shaped heat conduction layer 50a at a position where occurrence of a temperature increase is desired, the temperature of the connection section 24 of the printed circuit board 20 and the temperature of the connection section 34 of the flexible circuit board 30 can be increased at that position. Since the slit 14 crosses the circuit patterns 33, some of the circuit patterns 33 to be crossed inevitably oppose the heat conduction layer, so that the circuit patterns 33 can reliably be pressurized or heated. Thus, the circuit patterns can reliably be connected.

The foregoing fourth embodiment has mentioned the heat conduction layer 50 made of copper foil. However, the same can also be true of the heat conduction layer 51 formed from the shield described in connection with the second embodiment. Likewise, so long as the slit 14 is provided at a position on the strip-shaped heat conduction layer extended from the heat conduction layer 51, the temperatures of the connection sections 24 and 34 can be increased at the position of the slit 14.

### Fifth Embodiment

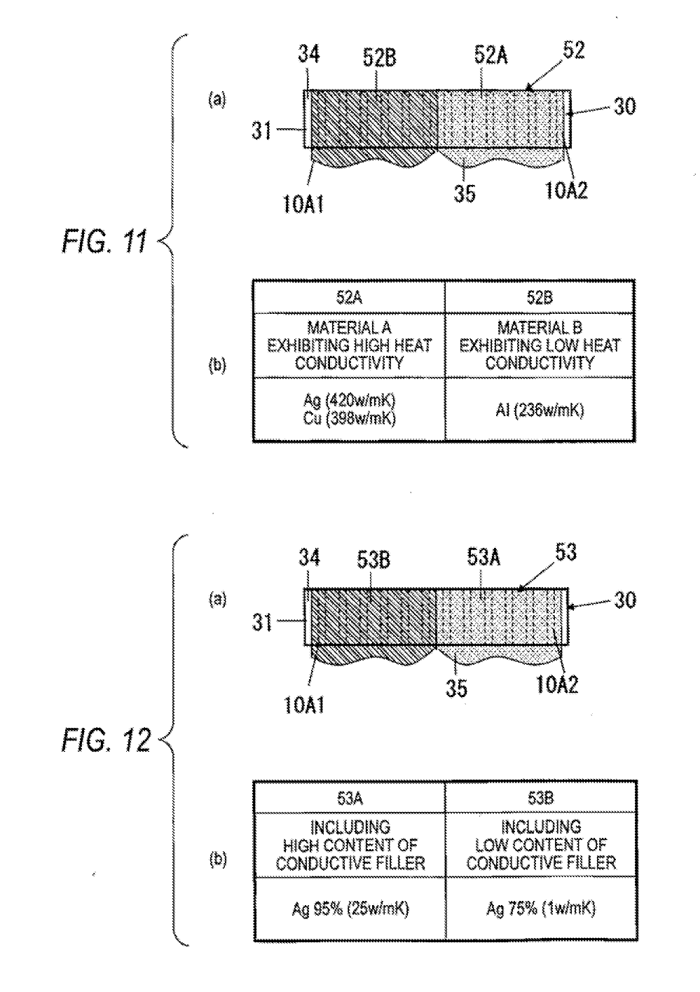

A fifth embodiment of the present invention is described by reference to FIG. 11. In the fifth embodiment, as shown in FIG. 11(a), a heat conduction layer 52, which includes a first heat conduction layer 52A and a second heat conduction layer 52B, is provided on the back surface (the first surface) that is on the other side of the front surface (the second surface) of the flexible circuit board 30 opposing the printed circuit board 20 (see FIG. 1), by utilization of the conductive shield 44 of the flexible joint section 43 in the same manner as described in connection with the second embodiment.

The first heat conduction layer 52A is provided at a part of the connection section 34 and the adjacent section 35 located adjacent to the connection section 34; namely, a region of the connection section 34 and the adjacent section 35 that is distant from the mount section 22 of the printed circuit board 20. The first heat conduction layer 52A opposes, at the region 10A2 that is distant from the mount section 22 of the printed circuit board 20, the circuit patterns 33 of the flexible circuit board 30 by way of the soft base material 31. The second heat conduction layer 52B is provided, while adjoining the first heat conduction layer 52A, at the other part of the connection section 34 and the adjacent section 35; namely, a region in the remaining part of the connection section 34 and the adjacent section 35 that is close to the mount section 22 of the printed circuit board 20 in the embodiment. The second heat conduction layer 52B opposes, at the region 10A1 close to the mount section 22 of the printed circuit board 20, the circuit patterns 33 of the flexible circuit board 30 by way of the soft base material 31. When the first heat conduction layer 52A and the second heat conduction layer 52B are provided while adjoining each other, a space may exist between the heat conduction layers.

The first heat conduction layer 52A exhibits a first quantity of heat conduction per unit time, and the second heat conduction layer 52B exhibits a second quantity of heat conduction per unit time that is smaller than the first quantity of heat conduction per unit time. In order to prepare the first heat conduction layer 52A and the second heat conduction layer 52B that exhibit such quantities of heat conduction, the essential requirement is to use a material A exhibiting high heat conductivity; for instance, silver (Ag) or copper (Cu), for the first heat conduction layer 52A and a material B exhibiting low heat conductivity; for instance, aluminum (Al), for the first heat conduction layer 52B, as shown in FIG. 11(b).

Moreover, an area SA2 of the first heat conduction layer 52A in the adjacent section 35 is greater than an area SA1 of the first heat conduction layer 52A in the connection section 34. Likewise, an area SB2 of the second heat conduction layer 52B in the adjacent section 35 is greater than an area SB1 of the second heat conduction layer 52B in the connection section 34. A correlation between the area SA1 and the area SA2 and a correlation between the area SB1 and the area SB2 are identical with the correlation between the area S1 and the area S2 described in connection with the first embodiment.

In the fifth embodiment, the first heat conduction layer 52A that is greater than the second heat conduction layer 52B in terms of the quantity of heat conduction per unit time is provided at the region of the connection section 34 and the adjacent section 35 of the flexible circuit board 30 that is distant from the mount section 22 of the printed circuit board 20. Hence, dissipation of heat from the region 10A2 of the connection section 24 of the printed circuit board 20 and the connection section 34 of the flexible circuit board 30 that is distant from the mount section 22 of the printed circuit board 20 can be made greater. Thus, the heating temperature of the region 10A1 of the connection sections 24 and 34 that is close to the mount section 22 and the heating temperature of the region 10A2 of the connection sections 24 and 34 that is distant from the mount section 22 can be made substantially equal. Moreover, the second heat conduction layer 52B that is smaller than the first heat conduction layer 52A in terms of the quantity of heat conduction per unit time is provided at the region of the connection section 34 and the adjacent section 35 of the flexible circuit board 30 distant from the mount section 22 of the printed circuit board 20. Hence, the chance of occurrence of a temperature difference between the connection section 24 and the connection section 34 can be lessened.

Moreover, the essential requirement is to use each of metals exhibiting different thermal conductivities in its proper way for the first and second heat conduction layers 52A and 52B. Hence, the heat conduction layers 52A and 52B can be provided to the same thickness. Hence, the entirety of the circuit patterns 33 of the connection section 34 can be evenly pressure-bonded to the circuit patterns 23 of the connection section 24 of the printed circuit board 20.

### Sixth Embodiment

A sixth embodiment of the present invention is described by reference to FIG. 12. In the sixth embodiment, as shown in FIG. 12(a), the flexible circuit board 30 has, on the back surface (the first surface) that is on the other side of the front surface (the second surface) opposing the printed circuit board 20, a heat conduction layer 53 made up of a first heat conduction layer 53A and a second heat conduction layer 53B by means of a conductive shield. Conductive paste including a conductive filler is used for the conductive shield making up the heat conduction layer. In the present embodiment, as shown in FIG. 12(b), conductive paste including a high content of silver filler is used for the first heat conduction layer 53A, and conductive paste including a low content of silver filler is used for the second heat conduction layer 53B. In other respects, the sixth embodiment is structurally identical to the fifth embodiment. In FIG. 12(a), the reference numerals that are the same as those employed in FIG. 11(a) designate the same elements.

As in the fifth embodiment, even in the sixth embodiment, the first heat conduction layer 53A that is greater than the second heat conduction layer 53B in terms of the quantity of heat conduction per unit time is provided at the region of the connection section 34 and the adjacent section 35 of the flexible circuit board 30 that is distant from the mount section 22 of the printed circuit board 20. Hence, there can be made greater the quantity of heat dissipated by the region 10A2 of the connection section 24 of the printed circuit board 20 and the connection section 34 of the flexible circuit board 30 that is distant from the mount section 22 of the printed circuit board 20. Thus, the heating temperature of the region 10A1 of the connection sections 24 and 34 that is close to the mount section 22 and the heating temperature of the region 10A2 of the connection sections 24 and 34 that is distant from the mount section 22 can be made substantially equal to each other. Further, the second heat conduction layer 53B that is smaller than the first heat conduction layer 53A in terms of the quantity of heat conduction per unit time is provided at the region of the connection section 34 and the adjacent section 35 of the flexible circuit board 30 that is distant from the mount section 22 of the printed circuit board 20. Hence, the chance of occurrence of a temperature difference between the connection sections 24 and 34 can be lessened.

The essential requirement for preparing the first heat conduction layer 53A and the second heat conduction layer 53B is to change the quantity of conductive filler included in the conductive paste. Therefore, the heat conduction layer 53A and the heat conduction layer 53B can be provided to the same thickness. The entirety of the circuit patterns 33 of the connection section 34 can be evenly pressure-bonded to the circuit patterns 23 of the connection section 24 of the printed circuit board 20.

### Seventh Embodiment

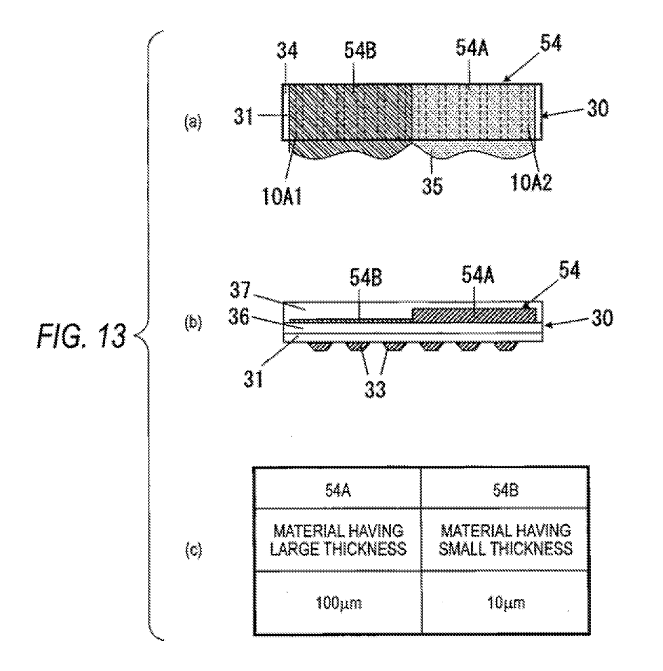

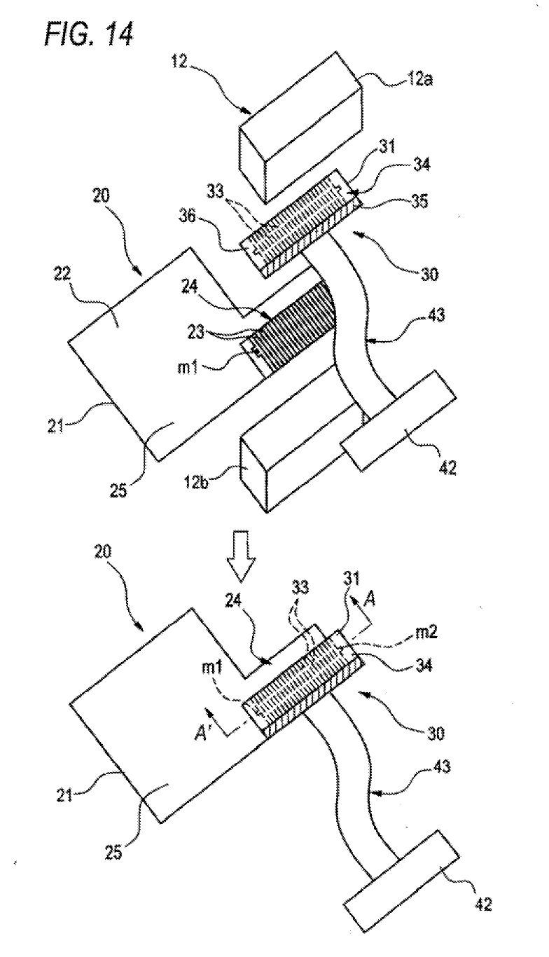

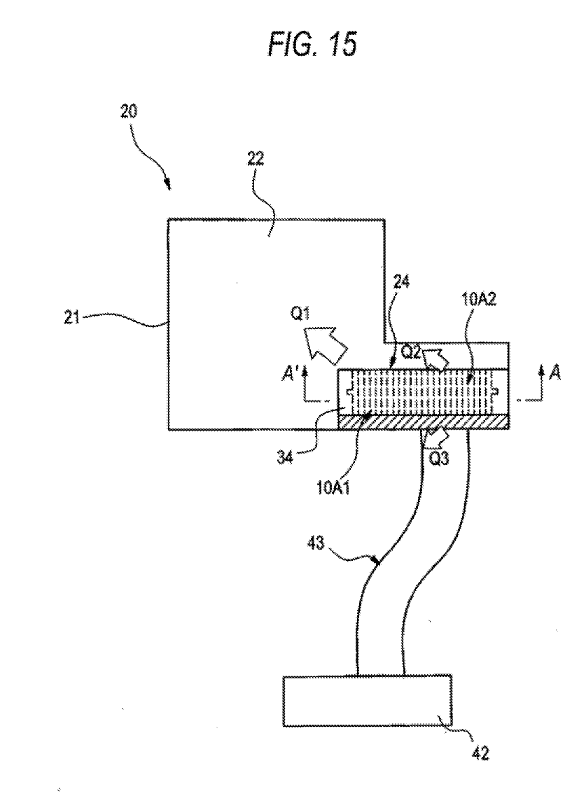

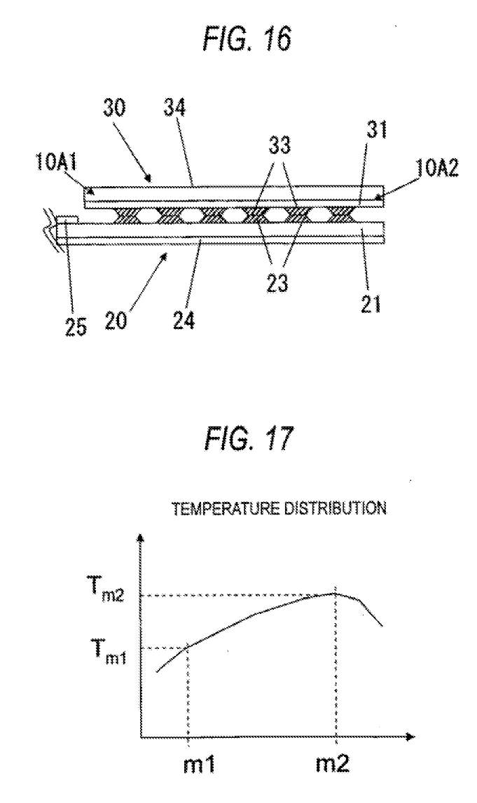

A seventh embodiment of the present invention is now described by reference to FIG. 13. As shown in FIGS. 13(a) and 13(b), the sixth embodiment is characterized in that the heat conduction layer is formed from a conductive shield over the back surface of the soft base material 31 of the flexible circuit board 30 so as to have varying thicknesses, to thus form a heat conduction layer 54 made up of a first heat conduction layer 54A and a second heat conduction layer 54B. As shown in FIG. 13(c), the material of the conductive shield is made thicker in the first heat conduction layer 52A, and the material of the conductive shield is made thinner in the second heat conduction layer 53B. The thickness of the entire flexible circuit board 30 is made substantially uniform by means of the coverlay 36 and the overcoat 37 covering the heat conduction layer 54 from above. In other respects, the seventh embodiment is structurally identical to the sixth embodiment. In FIG. 13(a), the reference numerals that are the same as those employed in FIG. 12(a) designate the same elements.

Even the seventh, embodiment yields the same working effects as those yielded by the fifth and sixth embodiments.

In the embodiments, the printed circuit board (the first circuit board) and the flexible circuit board (the second circuit board) are connected together. The present invention is not limited to such a combination of circuit boards and can be applied to a connection of an arbitrary type of circuit board to a circuit formation device (an MID or the like).

In the embodiment, the printed circuit board (the first circuit board) is made up of the rectangular mount section 22 and the elongated connection section 24 (the connection region) that projects from one end of the mount section 22. The printed circuit board assumes an L-shaped geometry when viewed in pane. However, the present invention is not restricted to the shapes in relation to the shape of the circuit board to which the present invention applies. The present invention can be applied to all circuit boards and circuit formation devices that will cause unevenness of heating temperature during connecting operation, such as that shown in FIG. 17, in an area of a connection between two circuit boards.

Although various embodiments of the present invention have been described thus far, the present invention is not restricted to the items referred to in the embodiments. It is also expected that those who are versed in the art will make alterations or applications to the present invention on the basis of the claims, the descriptions of the specification, and the known techniques, and the alterations or applications shall fall within a range where protection of the present invention should be sought.

The present patent application is based on Japanese Patent Application (JP-A-2009-196827) filed on Aug. 27, 2009, the entire subject matter of which is incorporated herein by reference.

### INDUSTRIAL APPLICABILITY

The present invention makes it possible to provide a board connection structure that can prevent occurrence of a connection failure by preventing an uneven temperature increase in a connection region of circuit boards during thermo-compression bonding of two circuit boards by use of a conductive connection material and provide electronic equipment having the board connection structure.

### DESCRIPTIONS OF THE REFERENCE NUMERALS AND SYMBOLS

10 Board Connection Structure
10A1 Region Close to Mount Section
10A2 Region Distant From Mount Section
14 Slit
20 Printed Circuit Board
21 Hard Base Material
22 Mount Section
23 Circuit Pattern
24 Connection Section (Connection Region)
30 Flexible Circuit Board
31 Soft Base Material
33 Circuit Pattern
34 Connection Section (Connection Region)
35 Adjacent Section
43 Flexible Joint Section
44 Shield
50 Heat Conduction Layer
50a Strip-Shaped Heat Conduction Layer
51 Heat Conduction Layer
52 to 54 Heat Conduction Layer
52A to 54A First Heat Conduction Layer
52B to 54B Second Heat Conduction Layer

1. A substrate connection structure, comprising:
a first circuit board including a base material that has a first surface and a second surface and a plurality of circuit patterns provided on the second surface;
a second circuit board including a base material that has a first surface and a second surface and a plurality of circuit patterns provided on the second surface;
a connection region connecting the circuit patterns of the first circuit board to the circuit patterns of the second circuit board by a conductive connection material; and
a heat conduction layer that is provided on the first surface of the second circuit board and that exhibits predetermined heat conductivity which surpasses heat conductivity of the base material of the second circuit board,
wherein the heat conduction layer opposes a part of the plurality of circuit patterns of the second circuit board by the base material of the second circuit board and is provided so as to extend from a part of the connection region to a region adjacent to the connection region;
the heat conduction layer is provided in another part other than the part of the connection region as to face the plurality of circuit patterns;
the heat conduction layer in the other part of the connection region is formed into a strip shape;
a slit is formed in the strip-shaped heat conduction layer; and
the slit is provided at a position in the connection region where the strip-shaped heat conduction layer crosses opposing circuit patterns.

2. The substrate connection structure according to claim 1, wherein an area of the heat conduction layer provided in a region located adjacent to the connection region is larger than an area of the heat conduction layer provided in a part of the connection region.

3. The substrate connection structure according to claim 1, wherein the conductive connection material includes a hot-melt conductive material or a thermosetting conductive resin.

4. The substrate connection structure according to claim 1, wherein an opening window is formed in the connection region of the second circuit board;
alignment marks are provided in the connection region of the first circuit board and the connection region of the second circuit board; and
an overlap between the alignment marks of the first circuit board and the second circuit board is observable through the opening window.

5. The substrate connection structure according to claim 1, wherein the heat conduction layer is formed from metal.

6. The substrate connection structure according to claim 5, wherein the heat conduction layer and the circuit patterns of the second circuit board are formed from the same metal.

7. The substrate connection structure according to claim 1, wherein the heat conduction layer is formed from a conductive resin.

8. The substrate connection structure according to claim 7, wherein the conductive resin is provided on a flexible board connected to the connection region.

9.-12. (canceled)

13. Electronic equipment comprising the substrate connection structure according to claim 1.

14. The substrate connection structure according to claim 1, wherein the connection region correspond to a region where the first circuit board and the second circuit board are electrically connected together when the connection region is subjected to pressure and heat for a predetermined period of time by a compression bonding tool.
